(19) United States
(12) Patent Application Publication
(10) Pub. No.: US 2002/0065670 A1
(43) Pub. Date: May 30, 2002

(54) System of providing agency service for customer management and method thereof

(75) Inventors: Dong Kwon Cho, Yusung-Gu (KR); Byeong Wook Lee, Yusung-Gu (KR)

Correspondence Address: GRAYBEAL, JACKSON, HALEY LLP, 155 - 108TH AVENUE NE, SUITE 350, BELLEVUE, WA, 98004-5901, US

(73) Assignee: Korea Telecommunication Authority

(21) Appl. No.: 09/752,981

(22) Filed: Dec. 29, 2000

(30) Foreign Application Priority Data
Nov. 24, 2000 (KR) 2000-70422

(51) Int. Cl. G06F 17/60

(52) U.S. Cl. 705/1; 379/242; 379/90.01

(57) ABSTRACT

The present invention relates to a system of providing an agency service for customer management using a CTI (Computer Telephony Integration) technique and a method thereof. The system comprises a system of providing an agency service for customer management having a switchboard, a CTI server and a subscriber management module, and a call center of an enterprise mutually connected to the system. By means of such construction, the enterprise using the system can easily ascertain customer information previously constructed in the system to rapidly and effectively carry out counsel with a subscriber. The system of providing an agency service for customer management using a CTI technique can reduce costs of investment and maintenance required for expensive equipments, associated experts and the like.

### TECHNICAL FIELD

The present invention relates to a system of providing an agency service for customer management and a method thereof. Specifically, the present invention relates to a system of providing an agency service for customer management acting for subscriber information management of external enterprises and connection of a subscriber to a counselor.

### BACKGROUND OF THE INVENTION

Recently, the number of customer management systems using a CTI (Computer Telephony Integration) technology is increasing, the CTI technology enabling information resources of separate apparatuses to be held in common by means of connection between a switchboard and a computer. For that reason, the enterprises or companies constructing a customer management system can carry out counsel with customers rapidly and effectively by easily ascertaining customer information previously constructed and thus can provide full services for customers who want rapid services.

However, the customer management system carrying out various functions generally requires expensive equipments, associated software, associated software experts and the like in constructing the system.

Namely, expensive equipments such as a switchboard with maximum capacity and performance, a CTI server, a customer database server and the like are required, and also associated software experts of high pay is required. Also, the software controlling switchboard and counselors work is required, and other equipments such as statistical processing system and gateway for host communication are further required.

For these reasons, there is a problem that the customer management system including the CTI server needs much investment and maintenance costs in constructing thereof.

### SUMMARY OF THE INVENTION

Therefore, the present invention is made in order to solve the above problem.

An object of the present invention is to provide a system of providing an agency service for customer management capable of being inexpensively used by smallscale enterprises not having specific experts and capital and a method thereof, in which a system of providing an agency service for customer management including a CTI server, a switchboard and a subscriber management module is mutually connected to a call center of an enterprise employing the system.

The above object can be accomplished by a system of providing an agency service for customer management, the system storing customer information of a customer who uses services of any enterprise and providing said customer information for a call center of said enterprise. The system comprises: a switchboard receiving a call from said customer who desires to enjoy services of said enterprise; a CTI server connecting said call connected via said switchboard to a counselor of said call center and at the same time, transmitting personal information and history information of said customer to said counselor; and a subscriber management module storing and managing information associated with an identification number service of said system and information associated with counsel result of said customer, and transmitting said associated information to said CTI server pursuant to an order of said CTI server.

The above object can be accomplished by a method of providing an agency service for customer management, in which customer information of a customer who uses services of any enterprise is stored and said customer information for a call center of said enterprise is provided. The method comprises: a first step of storing personal information and history information of said customer and respective identification numbers endowed with an identification number service of a system of providing the agency service for customer management; a second step of determining whether said customer is a counselee or a subscriber of said enterprise; a third step of connecting said customer to a counselor of said call center; and a fourth step of storing and managing a counsel result of said customer and updated personal information and history information of said customer.

According to the present invention, a terminal unit used for a system of providing an agency service for customer management is provided, the system storing customer information of a customer who uses services of any enterprise and providing said customer information for a call center of said enterprise. Said terminal unit connects a call of said customer received from said system to a counselor of said call center, at the same time, transmits personal information and history information of said customer to said counselor, and transmits a counsel result of said customer to said system.

Also, according to the present invention, a method of providing an online counseling service by connecting with a system of providing an agency service for customer management is provided, the system storing customer information of a customer who uses services of any enterprise and providing said customer information for a call center of said enterprise. The method comprises: a first step of transmitting a call received from said system and personal information and history information of said customer to a counselor of said call center; and a second step of transmitting a counsel result of said customer to said system.

According to the present invention, a CTI server used for a system of providing an agency service for customer management is provided, the system storing customer information of a customer who uses services of any enterprise and providing said customer information for a call center of said enterprise. The CTI server transmits a call of said customer to said call center, at the same time, transmits personal information and history information of said customer stored in said system to said call center, and determines whether said customer is a counselee or a subscriber of said enterprise by using an identification number service of said system.

The above object can be accomplished by a system of providing an agency service for customer management, the system storing customer information of a customer who uses services of any enterprise and providing said customer information for a call center of said enterprise. The system comprises: a switchboard receiving a call from said customer who desires to use services of said enterprise; a CTI server determining whether said customer connected via said switchboard is a counselee or a subscriber of said enterprise by using a name of said enterprise and an identification number which said customer inputs with an identification number service, when said customer is a subscriber, connecting said subscriber to a counselor of said call center, at the same time, transmitting personal information and history information of said subscriber to said counselor, and when said customer is a counselee, directly connecting said counselee to said counselor; a subscriber management module storing and managing information associated with said identification number service of said system and information associated with counsel result of said customer and transmitting said associated information to said CTI server pursuant to an order of said CTI server; and a terminal unit connecting said call connected via said CTI server to said counselor and transmitting said information associated with the counsel result of said customer to said CTI server.

Also, according to the present invention, a recording medium storing a program of storing customer information of a customer who uses services of any enterprise and providing said customer information for a call center of said enterprise is provided. The program carries out: a first step of storing a name of said enterprise, respective identification numbers with which a system of providing an agency service for customer management endows a subscriber, a counselee and said enterprise in an identification number service, respectively, and personal information and history information of said subscriber and said counselee; a second step of determining whether said customer is a counselee or a subscriber of said enterprise, when said call of said customer is connected; a third step of connecting said subscriber or said counselee to a counselor of said call center; and a fourth step of storing and managing a counsel result of said subscriber or said counselee.

### BRIEF DESCRIPTION OF THE DRAWINGS

The embodiments of the present invention will be explained with reference to the accompanying drawings, in which:

FIG. 1 is a block diagram of the whole system of providing an agency service for customer management according to an embodiment of the present invention; and

FIG. 2 is a flowchart showing operation of the system of providing an agency service for customer management according to an embodiment of the present invention.

### DETAILED DESCRIPTION OF THE INVENTION

The above objects, other objects, features and advantages of the present invention will be better understood from the following description taken in conjunction with the attached drawings.

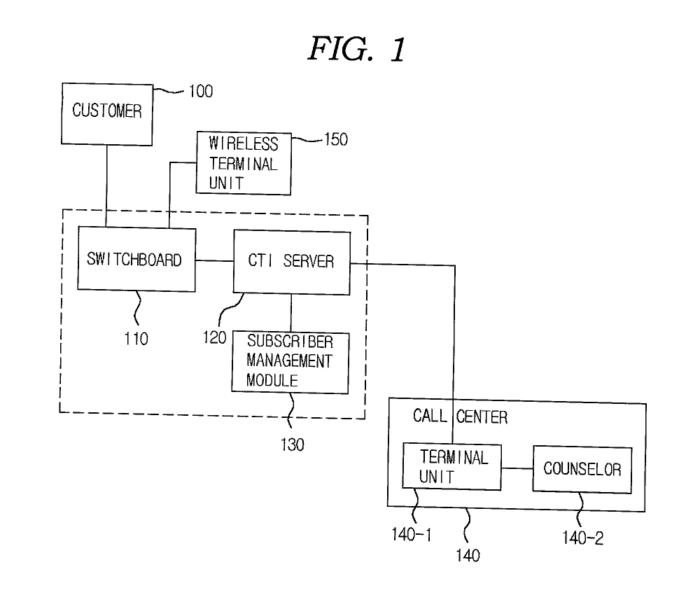

FIG. 1 is a block diagram of the whole system of providing an agency service for customer management according to an embodiment of the present invention.

Hereinafter, a customer who wants to use services of an enterprise employing a system of providing an agency service for customer management is referred to as a counselee, and a counselee previously subscribed to the enterprise employing the system of providing an agency service for customer management is referred to as a subscriber.

As a whole, a system of providing an agency service for customer management consists of a switchboard 110, a CTI server 120 and a subscriber management module 130. The CTI server 120 is mutually connected to a terminal unit 140-1 in a call center 140 of an enterprise employing a system of providing an agency service for customer management.

The switchboard 110 receives a call of a customer 100 who wants to use services of the enterprise.

The CTI server 120 receives the call of the customer 100 connected via the switchboard 110 and determines whether the connected customer 100 is a counselee or a subscriber of the corresponding enterprise by using an identification number service of said system described later. Then, when the customer is a subscriber to the corresponding enterprise, the CTI server 120 connects the subscriber to a counselor 140-2 of the enterprise and at the same time, transmits personal information and history information of the subscriber to the counselor 140-2. When the customer is a counselee, the CTI server 120 directly connects the counselee to the counselor 140-2 of the call center 140 without transmitting personal information and history information of the counselee to use the desired service.

The subscriber management module 130 stores and manages an identification number given to the enterprise with an identification number service, name of the enterprise (or company), the subscriber information and history information of the subscriber to the enterprise, an identification number of the subscriber and the like. Also, the subscriber management module 130 stores and manages the counsel result of the subscriber and the counsel result of the counselee received via a terminal unit 140-1 of the call center 140.

Here, when an actual serviceman dispatched from the call center 140 must be called out as a result of counsel with the counselee or the subscriber, the counselor 1402 in the call center 140 of the enterprise calls out the actual dispatched serviceman by using a wireless terminal 150 connected to the switchboard 110. Also, when the customer connected via the CTI server 120 is a counselee, not a subscriber of the enterprise, the counselor 140-2 registers the connected counselee as a subscriber of the enterprise and at the same time, transmits counselee information and history information of the counselee to the system via the terminal units 140-1 in the call center.

As described above, the case where the actual dispatched serviceman is called out pursuant to the counsel result of the counselor 140-2 is the case where the actual dispatched serviceman is required to visit the counselee or the subscriber, for example, the case where maintenance and repair of hardware or software provided by the enterprise is needed.

Here, an identification number service of the system will be explained. The system of providing an agency service for customer management endows enterprises (or companies) to use the system with enterprise identification numbers, endows subscribers belonging to the enterprise endowed with an enterprise identification number with subscriber identification numbers (for example, resident registration numbers), and endows counselee who want to use services of the enterprise with counselee identification numbers, respectively. Accordingly, when a subscriber or counselee inputs respective identification numbers, the subscriber or counselee is connected to a counselor of the enterprise to enjoy the desired services.

Namely, a subscriber who desires to enjoy services of the corresponding enterprise first calls a representative number of the system of providing an agency service for customer management and then sequentially inputs the enterprise identification number of the corresponding enterprise and the subscriber identification number. Then, the subscriber is directly connected to a counselor of the corresponding enterprise to enjoy the corresponding service.

On the other hand, when a counselee, he calls a representative number of the system of providing an agency service for customer management and then sequentially inputs the enterprise identification number of the corresponding enterprise and the counselee identification number. Then, the counselee is directly connected to a counselor of the corresponding enterprise to be registered as a subscriber and at the same time enjoy the corresponding service.

Now, operation of the system of providing an agency service for customer management constructed like this will be explained.

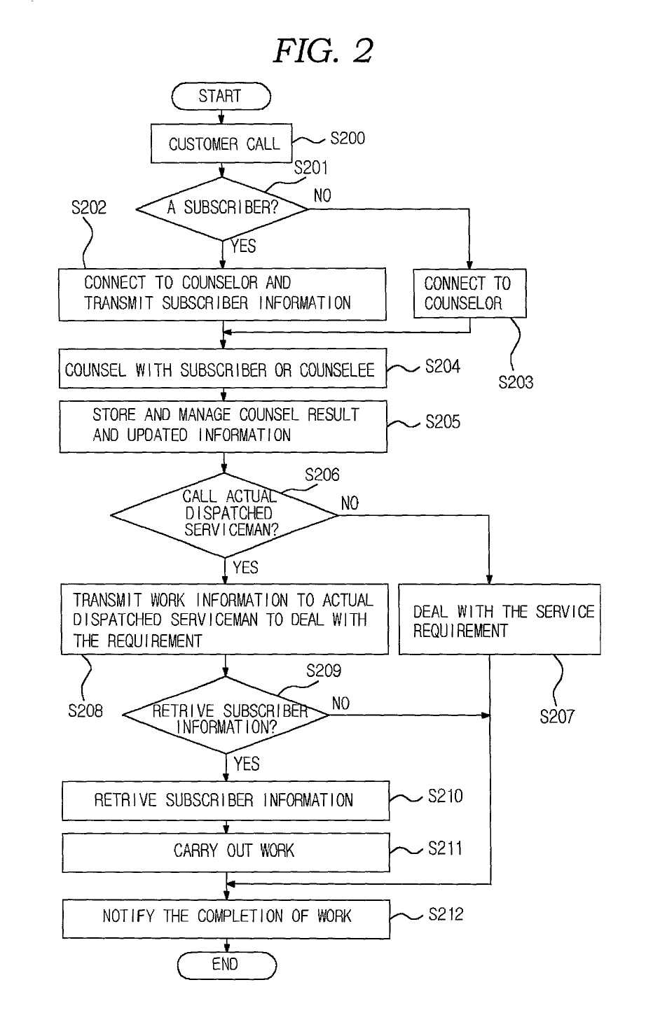

FIG. 2 is a flowchart showing operation of the system of providing an agency service for customer management according to an embodiment of the present invention.

A customer who desires to use services of an enterprise employing a system of providing an agency service for customer management calls a representative number of the system (S200). The system connected to a call of the customer determines whether the customer is a subscriber to the corresponding enterprise or a counselee with respective identification numbers input by the customer with an identification number service (S201). As a result of the determination, when the customer is a subscriber to the corresponding enterprise, the system directly connects the customer to a counselor of the corresponding enterprise and at the same time, transmits the subscriber information and history information of the subscriber to the counselor (S202). When the customer is a counselee, the system directly connects the customer to the counselor of the corresponding enterprise (S203). The counselor takes counsel with the subscriber or counselee (S204). At that time, when the customer is a counselee, the counselor registers the counselee as a subscriber of the corresponding enterprise, and then transmits subscriber information and history information to the system of providing an agency service of customer management.

Here, the subscriber information includes personal information such as a name (real name), a resident registration number and the like, and the history information includes accumulated score, bonus sum in the enterprise and the like.

The system of providing an agency service of customer management receives the counsel result of the subscriber with the counselor, personal information and history information of the updated subscriber or the counselee, and stores and manages the information (S205). As a result of counsel with the subscriber, the counselor of the enterprise determines whether an actual dispatched serviceman of the enterprise must be called out (S206). As a result of the determination, if the actual dispatched serviceman need not be called out, the counselor carries out work pursuant to the counsel result to process the requirement of the subscriber (S207). If the actual dispatched serviceman needs to be called out, the counselor completes the counsel with the corresponding subscriber, and then transmits personal information and history information of the corresponding subscriber, a work order (in which a sort of service and a substance of service required by the subscriber are described) and the like to an actual dispatched serviceman via a wireless terminal unit. The actual dispatched serviceman deals with the requirement of the subscriber (S208). At that time, the actual dispatched serviceman determines whether additional information of the corresponding subscriber is necessary (S209). If that additional information is necessary is determined, the actual dispatched serviceman notifies the system of the determination. The system additionally retrieves personal information and history information of the corresponding subscriber (S210) and transmits the retrieved information to the actual dispatched serviceman to enable the actual dispatched serviceman to carry out the service work (S211). When the requirement of the corresponding subscriber is settled, the counselor of the call center notifies the corresponding subscriber of the completion (S212).

According to the present invention as described above, small-scale enterprises can inexpensively deal with various services required by customers and manage customers without high costs and experts required for constructing a customer management system by using the system of providing an agency service for customer management according to the present invention.

Although technical spirits of the present invention has been disclosed with reference to the appended drawings and the preferred embodiments of the present invention corresponding to the drawings has been described, descriptions in the present specification are only for illustrative purpose, not for limiting the present invention.

Also, those who are skilled in the art will appreciate that various modifications, additions and substitutions are possible without departing from the scope and spirit of the present invention. Therefore, it should be understood that the present invention is limited only to the accompanying claims and the equivalents thereof, and includes the aforementioned modifications, additions and substitutions.

What is claimed is:

1. A system of providing an agency service for customer management comprising:
a switchboard receiving a call from said customer who desires to enjoy services of any enterprise;
a CTI server connecting said call connected via said switchboard to a counselor of a call center, and at the same time, transmitting personal information and history information of said customer to said counselor; and
a subscriber management module storing and managing information associated with an identification number service of said system and information associated with counsel result of said customer, and transmitting said associated information to said CTI server pursuant to an order of said CTI server,
wherein the system stories customer information of a customer who uses services of said enterprise and provides said customer information for said call center of said enterprise.

2. The system of providing an agency service for customer management according to claim 1, wherein said identification number service is a service that said system endows said enterprise with an enterprise identification number, a subscriber with a subscriber identification number and said counselor with a counselor identification number, respectively.

3. The system of providing an agency service for customer management according to claim 1, wherein said CTI server determines whether said customer is a counselee or a subscriber of said enterprise by using said identification numbers which said customer inputs with said identification number service.

4. The system of providing an agency service for customer management according to claim 1, wherein when said customer is a subscriber, said CTI server transmits the personal information and the history information of said subscriber to said counselor of said call center at the same time as connecting said subscriber to said counselor, and when said customer is a counselee, said CTI server directly connects said counselee to said counselor.

5. A method of providing an agency service for customer management comprising:
a first step of storing personal information and history information of said customer and respective identification numbers endowed with an identification number service of a system of providing the agency service for customer management;
a second step of determining whether said customer is a counselee or a subscriber of said enterprise;
a third step of connecting said customer to a counselor of said call center; and
a fourth step of storing and managing a counsel result of said customer and updated personal information and history information of said customer,
wherein the method stores customer information of said customer who uses services of any enterprise and provides said customer information for said call center of said enterprise.

6. The method of providing an agency service for customer management according to claim 5, wherein said identification number service is a service that said system endows said enterprise with an enterprise identification number, a subscriber with a subscriber identification number and said counselor with a counselor identification number, respectively.

7. The method of providing an agency service for customer management according to claim 5, wherein said second step is carried out by using said respective identification numbers which said customer inputs with said identification number service.

8. The method of providing an agency service for customer management according to claim 5, wherein said third step is carried out by transmitting the personal information and the history information of said subscriber to said counselor of said call center at the same time as connecting said subscriber to said counselor, when said customer is a subscriber.

9. A terminal unit used for a system of providing an agency service for customer management, wherein said terminal unit connects a call of said customer received from said system to a counselor of said call center, at the same time, transmits personal information and history information of said customer to said counselor, and transmits a counsel result of said customer to said system, and wherein the system stores customer information of said customer who uses services of any enterprise and provides said customer information for said call center of said enterprise.

10. The terminal unit used for a system of providing an agency service for customer management according to claim 9, wherein said terminal unit transmits updated personal information and history information of said subscriber to said system.

11. A method of providing an online counseling service by connecting with a system of providing an agency service for customer management comprising:
a first step of transmitting a call received from said system and personal information and history information of said customer to a counselor of said call center; and
a second step of transmitting a counsel result of said customer to said system,
wherein, the system stories customer information of said customer who uses services of any enterprise and provides said customer information for said call center of said enterprise.

12. The method of providing an online counseling service according to claim 11, wherein said second step is carried out by transmitting updated personal information and history information of said customer to said system.

13. A CTI server used for a system of providing an agency service for customer management,
wherein the CTI server transmits a call of said customer to said call center, at the same time, transmits personal information and history information of said customer stored in said system to said call center, and determines whether said customer is a counselee or a subscriber of said enterprise by using an identification number service of said system, and wherein the system stores customer information of said customer who uses services of any enterprise and provides said customer information for said call center of said enterprise.

14. The CTI server used for a system of providing an agency service for customer management according to claim 13, wherein said identification number service is a service that said system endows said enterprise with an enterprise identification number, a subscriber with a subscriber identification number and said counselee with a counselee identification number, respectively.

15. A system of providing an agency service for customer management comprising:
a switchboard receiving a call from said customer who desires to use services of said enterprise;
a CTI server determining whether said customer connected via said switchboard is a counselee or a subscriber of said enterprise by using a name of said enterprise and an identification number which said customer inputs with an identification number service, when said customer is a subscriber, connecting said subscriber to a counselor of said call center, at the same time, transmitting personal information and history information of said subscriber to said counselor, and when said customer is a counselee, directly connecting said counselee to said counselor;
a subscriber management module storing and managing information associated with said identification number service of said system and information associated with counsel result of said customer and transmitting said associated information to said CTI server pursuant to an order of said CTI server; and
a terminal unit connecting said call connected via said CTI server to said counselor and transmitting said information associated with the counsel result of said customer to said CTI server,
wherein, the system stores customer information of said customer who uses services of any enterprise and provides said customer information for said call center of said enterprise.

16. The system of providing an agency service for customer management according to claim 15, wherein said identification number service is a service that said system endows said enterprise with an enterprise identification number, a subscriber with a subscriber identification number and said counselor with a counselor identification number, respectively.

17. The system of providing an agency service for customer management according to claim 15, wherein said terminal unit transmits updated personal information and history information of said customer to said CTI server.

18. A recording medium storing a program, the program carrying out:
a first step of storing a name of said enterprise, respective identification numbers with which a system of providing an agency service for customer management endows a subscriber, a counselee and said enterprise in an identification number service, respectively, and personal information and history information of said subscriber and said counselee;
a second step of determining whether said customer is a counselee or a subscriber of said enterprise, when said call of said customer is connected;
a third step of connecting said subscriber or said counselee to a counselor of said call center; and
a fourth step of storing and managing a counsel result of said subscriber or said counselee,
wherein, said program stores customer information of said customer who uses services of any enterprise and provides said customer information for said call center of said enterprise.
